(19) United States
(12) Patent Application Publication
(10) Pub. No.: US 2014/0228052 A1
(43) Pub. Date: Aug. 14, 2014

(54) METHOD FOR ALERTING A MOBILE DEVICE AT A PREDETERMINED DESTINATION

(71) Applicant: Prashant Vashisht, Bangalore (IN)

(72) Inventor: Prashant Vashisht, Bangalore (IN)

(73) Assignee: ALCATEL LUCENT, Paris (FR)

(21) Appl. No.: 14/128,153

(22) PCT Filed: Jun. 18, 2012
(86) PCT No.: PCT/EP2012/061548

§ 371 Date: Apr. 8, 2014

(30) Foreign Application Priority Data
Jul. 1, 2011 (IN) 2261/CHE/2011

(51) Int. Cl. H04W 4/02

(52) U.S. Cl. CPC H04W 4/02
USPC 455/456.2

(57) ABSTRACT

A method for alerting a mobile device at a predetermined destination. The present invention concerns a method for alerting a mobile device at a predetermined destination, in particular for transport applications. A method for alerting a mobile device at a predetermined destination, said mobile device operating within a communication network, said method consisting in setting an geographic destination to an application server in said communication network, converting the geographic destination into a communication network coordinate system in association with a database, requesting regular location updates to a position determination entity of said communication network, sending a destination trigger event to said mobile device when said mobile device has reached said predetermined destination as determined by said position determination entity of said communication network.

### TECHNICAL FIELD

The present invention concerns a method for alerting a mobile device at a predetermined destination, in particular for transport applications.

### BACKGROUND

This section introduces aspects that may be helpful in facilitating a better understanding of the invention. Accordingly, the statements of this section are to be read in this light and are not to be understood as admissions about what is in the prior art or what is not in the prior art.

We know of notification systems calibrated to a particular time of the time. Such a notification system can take the form of an audible, visual, or tactile alarm.

As such, to take a specific example, when one is to take a train to a destination, and one wishes to be notified of the impending arrival, one may program an alarm at a specific time corresponding to the scheduled arrival of the train. The alarm may produce an audible sound, a visual indication, or a sensed (such as vibration) motion.

However, this solution is not entirely satisfactory as one may arrive at destination ahead or behind the scheduled arrival time.

Others have tried to solved this problem by proposing a GPS-type solution which compares the current location to that of the destination. However, such solutions are not possible without sophisticated equipment.

An alternative is thus sought to better deal with this situation.

### BRIEF SUMMARY

Example embodiments provide a method for alerting a mobile device at a predetermined destination, said mobile device operating within a communication network, said method consisting in:
setting an geographic destination to an application server in said communication network,
converting the geographic destination into a communication network coordinate system in association with a database
requesting regular location updates to a position determination entity of said communication network,
sending a destination trigger event to said mobile device when said mobile device has reached said predetermined destination as determined by said position determination entity of said communication network.

Other embodiments provide a software program product adapted for alerting a mobile device when arriving at a predetermined destination, said software product being adapted to:
receive a destination location request from a mobile terminal
interrogate a database for the coordinate location corresponding to the destination location
triggered a regular location update from a communication network

Yet further embodiments provide a use of the method disclosed hereabove, in an application consisting of a user of a rail transportation network setting an alert for a destination station, and said application server send the user a destination trigger event upon arrival at destination.

An advantage of these embodiments is that it provides a user a device-independent way of being alerted of arrival at a destination. Indeed, any portable device in communication with an appropriate communication network is adapted for working this method, without requiring the use of technologically advanced individual localization technology.

### BRIEF DESCRIPTION

Some embodiments of devices and methods in accordance with embodiments of the present invention are now described, by way of example only, and with reference to the accompanying drawings, in which:

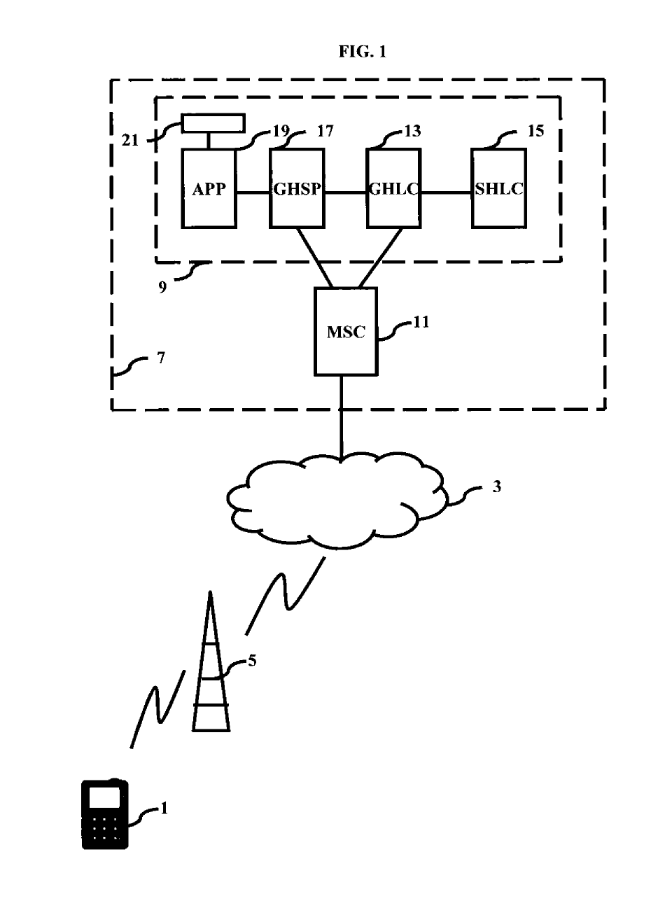

FIG. 1 illustrates schematically a communication network according to a first embodiment;

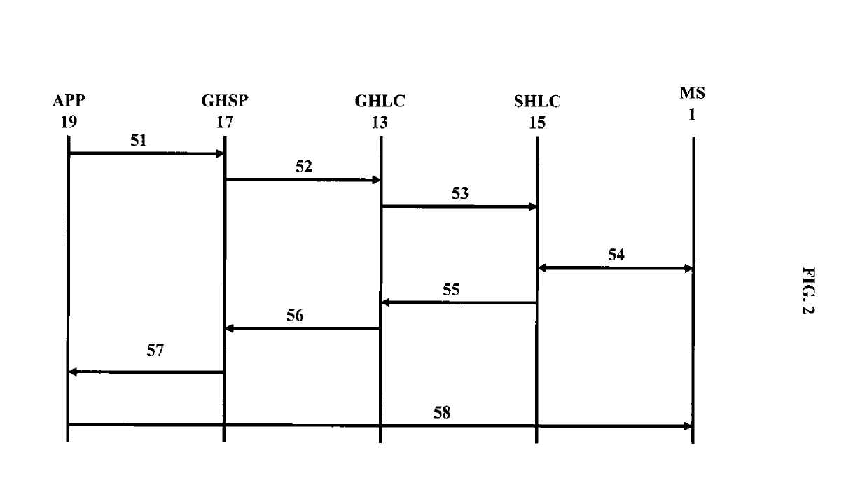

FIG. 2 illustrates a call flow diagram for a communication network according to FIG. 1.

### DETAILED DESCRIPTION

FIG. 1 illustrates a mobile communication architecture according to a first embodiment, comprising:
Mobile device 1, commonly referred to as Mobile Station (MS), comprising a User Equipment and a Subscriber Identity Module (SIM) card;
Access network 3, comprising wireless communication antenna 5, for example, BTS, Node-B, etc.; and
Core network 7

The core network 7 comprises inter alia the equipment necessary for a communication network, as readily known to the skilled person. The core network 7 further comprises a control plane mobile device localization system 9, hereinafter referred to as a localization system 9.

The present embodiment makes reference to the GSM communication network standard, and as such the terms used hereafter will refer to this standard.

The localization system 9 is in communication with a Mobile Switching Centre (MSC) 11 of the core network 7. The MSC 11 is adapted to set up and release end-to-end connection, as well as being the primary service delivery node for GSM/CDMA networks, responsible for routing voice calls and SMS as well as other services (such as conference calls, FAX and circuit switched data, and localization services).

The localization system 9 comprises:
GMLC 13, or “gateway mobile location centre”;
SMLC 15, or “serving mobile location centre”; and
GMSP 17.

It is to be noted that the above entities are indicative only of the GSM network and may be readily converted to other standards and networks. For example, for ANSI-41 standard, the GMLC is equivalent to MPC (“Mobile Position Controller”), SMLC is equivalent to PDE (“Position Determination Entity”).

The GMSP 17 comprises an API layer with which interfaces a location based service application processor 19 (hereinafter referred to as LBS app 19).

The LBS App 19 is adapted to manage individual location notification requests from subscribers. The LBS app 19 comprises storage means 21 for storage such information.

The storage means 21 may comprise a database adapted for converting semantic location information to coordinate system more adapted to the location indication returned by the localization system 9.

For example, semantic information may be similar to “Paris” or “Penn train station”; coordinate information handled by the localization system 9 may be based on GPS coordinates, such as: “48.856667; 2.350833”, or “40.750638; 73.993899”.

The LBS App 19 is adapted to contact the GMSP with the current location details of the subscribers along with the destination details where the subscriber wants to be alerted.

The LBS App 19 is further adapted to trigger a notification on the mobile device 1. A notification may for example be an audio alarm, a visual indicator, or may trigger a vibration-generating device.

According to a variant, the LBS App 19 is also adapted to coordinate with the MSC to trigger a server-originating voice call to the mobile device 1.

FIG. 2 illustrates the high level call flow for the operation of the embodiment of FIG. 1.

As a preliminary step, the mobile device 1, via the intermediary of its subscriber, needs to activate the services of the LBS App 19. For this, the mobile device 1 may send a registration request to the LBS App 19 via the MSC 11 with an indication of the arrival destination at which he should be notified. This indication may be semantic, in which case the LBS App 19 converts the information to absolute coordinates, or the indication may be directly in absolute coordinates.

According to a variant embodiment, the LBS App 19 may be set using a remote internet portal.

At step S1, the LBS App 19 contacts the GMSP 17 with the current destination location of where the mobile device 1 wants to be alerted.

At step S2, the GMSP 17 requests a location update of the mobile device 1 by sending a request to the GMLC 13 to get the position of the mobile device 1.

At step S3, the GMLC 13 starts a session with the SMLC 15 in order to start calculating the position of the mobile device 1. In parallel, the GMLC 13 may request for the MSC 11 to page device in order to set up a traffic channel to the device 1.

At step S4, the SMLC 15 exchanges data with the mobile device 1 in order to triangulate the position of the mobile device 1. For example, AFLT algorithm may be used.

At step S5, the SMLC 15 returns the determined position of the mobile device 1 to the GMLC 13.

At step S6, the GMLC 13 forwards the position to the GMSP 17.

At step S7, the GMSP 17 compares the location as returned from GMLC 13 with the destination location requested by the LBS App 19. If the position of the mobile device 1 as determined by the SMLC 15 compares favourably with the destination location requested by the LBS App 19, then GSMP 17 sends a trigger to the LBS App 19.

At step S8, the LBS App 19 acts on trigger by alerting the mobile device 1. The alert may consist of: SMS message, phone call, remote alarm trigger, visual alarm, remote mobile device vibration.

According to other embodiments of the present invention, the above-described system and method may be used in particular in alerting users carrying a mobile device 1 of future stops along the route. This is particularly advantageous when the route has an unreliable timetable, and when the mobile device is of a type where GPS is not available.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

1. A method for alerting a mobile device at a predetermined destination, said mobile device operating within a communication network, said method comprising:
setting an geographic destination to an application server in said communication network,
converting the geographic destination into a communication network coordinate system in association with a database
requesting regular location updates to a position determination entity of said communication network,
sending a destination trigger event to said mobile device when said mobile device has reached said predetermined destination as determined by said position determination entity of said communication network.

2. A method according to claim 1, wherein the mobile device communicates with the application server to record an alert destination

3. A method according to claim 1, wherein the alert destination is set in the application server via an Internet website interface.

4. A software program product adapted for alerting a mobile device when arriving at a predetermined destination, said software product being adapted to:
receive a destination location request from a mobile terminal
interrogate a database for the coordinate location corresponding to the destination location
triggered a regular location update from a communication network.

5. Use of the method according to claim 1, in an application comprising of a user of a rail transportation network setting an alert for a destination station, and said application server send the user a destination trigger event upon arrival at destination.
